(19) United States
(12) Patent Application Publication
(10) Pub. No.: US 2026/0087680 A1
(43) Pub. Date: Mar. 26, 2026

(54) REINFORCEMENT LEARNING-BASED RATE CONTROL FOR END-TO-END NEURAL NETWORK BASED VIDEO COMPRESSION

(71) Applicant: INTERDIGITAL VC HOLDINGS, INC., Wilmington, DE (US)

(72) Inventors: Fabien RACAPE, San Francisco, CA (US); Ujwal DINESHA, College Station, TX (US); Hyomin CHOI, Sunnyvale, CA (US); Syed Mateen UL HAQ, Mountain View, CA (US)

(21) Appl. No.: 19/114,220

(22) PCT Filed: Sep. 22, 2023
(86) PCT No.: PCT/US2023/033459

§ 371 Date: Mar. 21, 2025

Related U.S. Application Data
(60) Provisional application No. 63/409,271, filed on Sep. 23, 2022.

(51) Int. Cl. G06T 9/00; H04N 19/177

(52) U.S. Cl. CPC G06T 9/002; H04N 19/177

(57) ABSTRACT

An end-to-end neural network-based rate control method based on reinforcement learning implements video codec embodiments. In one embodiment, the codec environment is based on an Asymmetric Gained Variational Auto-Encoder (AG-VAE) architecture. A Reinforcement Learning (RL) agent is implemented through a deep convolutional neural network. In an embodiment, the RL agent conveys a choice of gain vector to the AG-VAE codec and receives reward data from the AG-VAE environment. Rate control is optimized over a period of frames, such as a Group of Pictures (GOP).

### CROSS REFERENCE TO RELATED APPLICATION

This application claims the benefit of U.S. Application Ser. No. 63/409,271, filed Sep. 23, 2022, which is incorporated by reference herein in its entirety.

### TECHNICAL FIELD

At least one of the present embodiments generally relates to a method or an apparatus for compression of images and videos using Neural Network based tools.

### BACKGROUND

Compression of video content using novel Artificial Neural Network (ANN)-based tools is an area being studied by the Joint Video Exploration Team (JVET) between ISO/MPEG and ITU to replace some modules of the latest standard H.266/VVC, as well as the replacement of the whole structure by end-to-end auto-encoder methods in a longer term. Encoding video content at the highest quality possible within a bit budget constraint, at sequence or subsequence level, in the context of end-to-end ANN-based video compression is one goal of such studies.

### SUMMARY

At least one of the present embodiments generally relates to a method or an apparatus in the context of the compression of images and videos using novel Artificial Neural Network (ANN)-based tools. In particular, one objective of the described embodiments is encoding video content at the highest quality possible within a bit budget constraint, at sequence or subsequence level, in the context of end-to-end ANN-based video compression.

According to a first aspect, there is provided a method. The method comprises steps for encoding a portion of video using a determined number of bits; and, determining the number of bits to allocate for the encoded portion of video based on a number of frames, wherein said determining comprises using a gain vector from a reinforcement learning agent that uses a latent determined from the encoding

According to a second aspect, there is provided a method. The method comprises steps for parsing video data for a lambda value; determining an index of a vector with corresponding lambda that is closest to a target lambda value, wherein lambda defines a rate-distortion operating point; interpolating values of vectors between the determined index vector and one having a consecutive index, using the target lambda value and lambda values of the vectors between the determined index vector and one having a consecutive index; and, decoding the video data using the interpolated vectors.

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

According to another general aspect of at least one embodiment, there is provided a non-transitory computer readable medium containing data content comprising instructions to perform any of the encoding or decoding methods.

### BRIEF DESCRIPTION OF THE DRAWINGS

FIG. 1 illustrates a random access structure with GOPs of 8 frames.

FIG. 2 illustrates a reinforcement learning framework.

FIG. 3 illustrates a basic autoencoder for image compression.

FIG. 4 illustrates a basic AG-VAE architecture.

FIG. 5 illustrates a basic end-to-end NN-based video compression framework.

FIG. 6 illustrates gained video compression auto-encoders.

FIG. 7 illustrates a proposed RL based rate distortion optimization scheme.

FIG. 8 illustrates a system with another video compression model.

FIG. 9 illustrates an AG-VAE on top of a hyperprior-based autoencoder architecture.

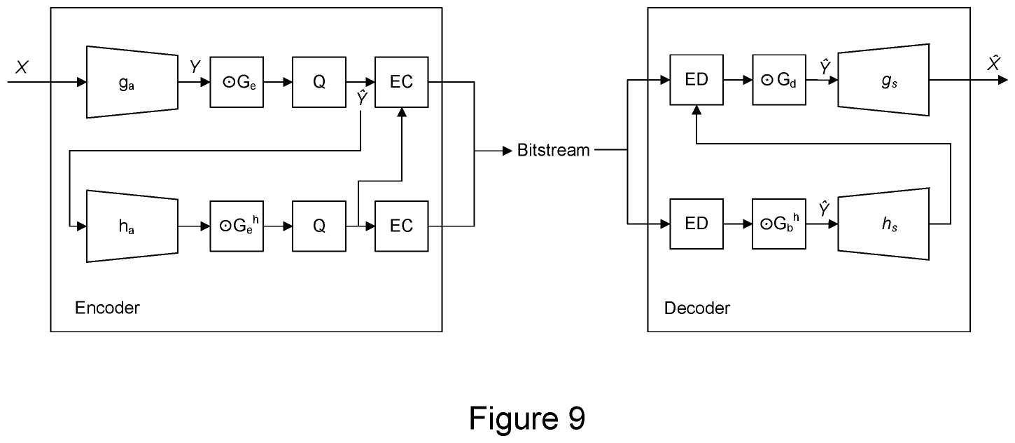

FIG. 10 illustrates one embodiment of a method for encoding video using the described embodiments.

FIG. 11 illustrates one embodiment of a method for decoding video using the described embodiments.

FIG. 12 illustrates one embodiment of an apparatus for encoding or decoding using the described embodiments.

FIG. 13 illustrates a standard, generic video compression scheme.

FIG. 14 illustrates a standard, generic video decompression scheme.

FIG. 15 illustrates a processor-based system for encoding/decoding under the general described aspects.

### DETAILED DESCRIPTION

In traditional video compression, specific temporal structures enable the encoder to select reference frames among previously decoded pictures to optimize the encoding of each frame, but also to manage the bit budget per frame. Certain key frames will be used as reference to predict the other frames. It is then relevant to ensure that they will be encoded at the right quality.

A typical structure that is used in the broadcast ecosystem is named Random Access Structure. It is composed of periodic Groups of Pictures (GOPs) which consist of the minimal temporal timeframe structure, that is repeated.

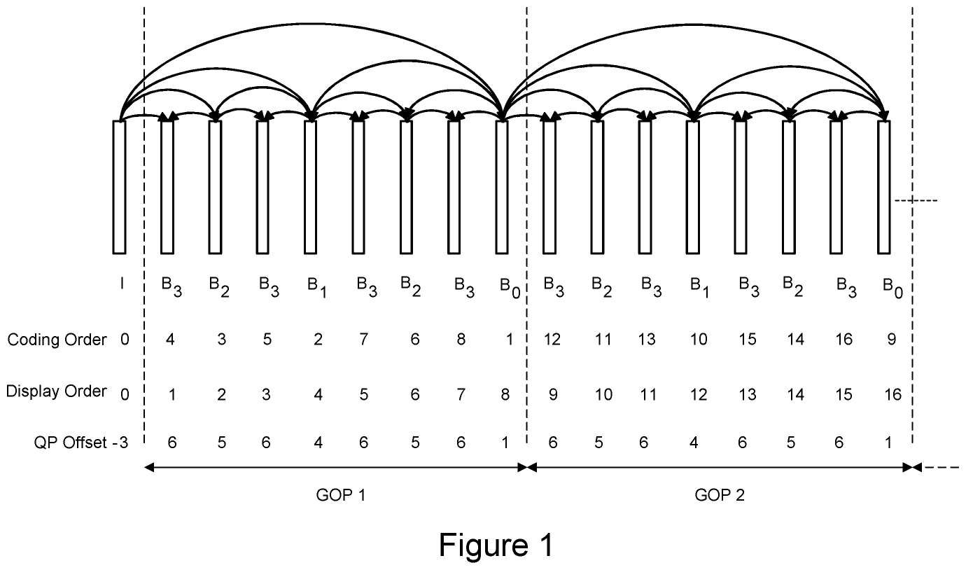

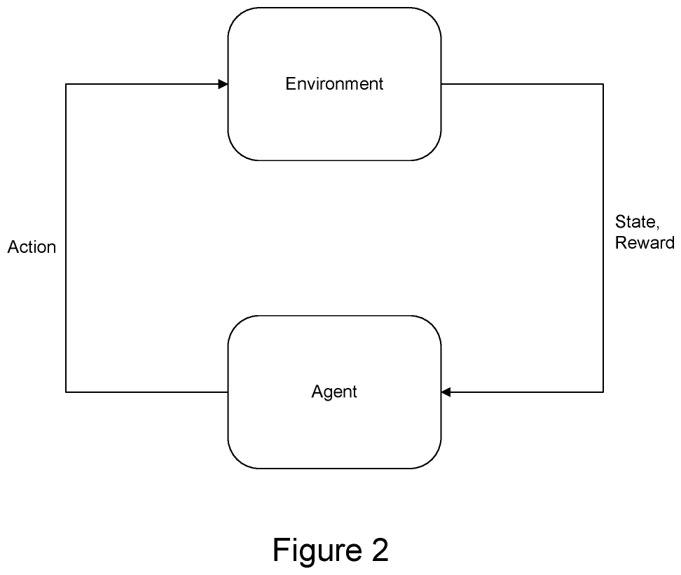

FIG. 1 illustrates such a structure in the case of a GOP of 8 frames. The first frame is an Intra frame, or I-frame, meaning that it does not depend on other frames to be decoded. It can then be used as a random-access point, where a decoder can start decoding a sequence. In broadcast, they are typically separated by a second of video, which enables TV viewers to switch channels and start decoding the new channel they selected, and not wait for too long for the video to start being displayed. However, these frames usually cost a lot of bits to transmit since they are not predicted using previously decoded content. In between I frames, the other frames are predicted using previously decoded frames. In the structure of FIG. 2, one can notice that the coding order is different from the order of display. This enables the encoder to predict the frames using past and future previously reconstructed pictures. These frames are hence called B frames for bi-directional prediction. The B₀ of each GOP is the first frame to be coded, it is predicted using the last key frame (I or B₀) from previous GOPs, e.g., frame 8 in display order is predicted from frame 0. The following frames in coding order can be predicted using past and future frames, as depicted by the arrows. Frames B₁ can use frames of type I, B₀, frames B₂ can be predicted from frames I, B₀ and B₁ etc.

To manage the bit budget among the different types of frames, a typical Quantization Parameter (QP) offset is shown in FIG. 1, which corresponds to the default QP structure used in the reference software of HEVC/H.265. In other words, if the nominal QP selected for a sequence is 30, I frames will be coded at QP-27, B₀ frames at 31 etc.

As can be seen, the QP assigned per frame is independent of the video content, i.e., textures, motion, etc., in the input signal, it only depends on a pre-fixed temporal structure. However, this is suboptimal since better tradeoffs can be found when accounting for how efficient the compression will be on sub parts of sequences and images. For instance, if a still sequence is encoded, it would have been preferable to allocate a larger bit budget for the first I frame, since the subsequent frames are supposed to cost very few bits, after being temporally predicted.

Traditional video compression standards can reach low bitrates by predicting to reduce redundancies, decorrelating the signal with transforms and entropy coding, but also degrading the videos based on signal fidelity or visual quality. The performance of the compression is then evaluated by looking at the size of the bitstream, i.e., the required number of bits required, for storing or transmitting a video at a given reconstructed quality after decoding. Codecs are then characterized by the quality of the decoded content as a function of the bitrate.

To adapt to a so-called rate-distortion tradeoff, traditional encoders can adapt their quantization parameter QP which will drive the quantization step of transmitted data and then the distortion introduced in the reconstructed content.

Rate-Distortion Optimization (RDO) refers to the algorithms used by the encoder to minimize the transmitted bits for a given targeted reconstructed quality. Traditional encoders partition the images into non overlapping blocks of different shapes and sizes. Then, intra or inter prediction and transforms are applied to reduce the redundancies with previously coded content. Finally, transformed prediction residuals are quantized and entropy coded. In this chain of processes, only the quantization part is lossy. However, the optimizations on the bitrate reduction can be made at all levels by the encoder: choices in sizes of blocks, prediction, transforms, quantization. To that end, the optimization process aims at minimizing the Lagrangian criterion

$$J = R + λ D ,$$

where R denotes the rate, i.e., the number of bits required to represent a picture or group of pictures, and D represents the distortion or quality of the reconstructed pictures at the decoder. Lambda is a parameter which defines at which rate-distortion tradeoff, or operation point, the codec is used.

Note that D can be measured using different quality metrics such as MSE (Mean Squared Errors), SSIM, (Structural Similarity) etc. However, in traditional video codec, D is limited to be summable over the blocks. Indeed, when the encoder decides between encoding a block directly or split it into smaller blocks, it needs to compute and compare the rate-distortion tradeoff in both cases, which requires to sum the costs of the smaller blocks. This limitation often forces traditional encoders to use the MSE as base criterion.

Rate Control consists of maximizing the quality of the reconstructed video under the constraint of a bitrate. Since the quantization parameter can be chosen at frame or block level, the encoder needs to plan the expected bitrate of the next frames since the frames are encoded sequentially. In most applications, encoders don't have the time to perform multiple passes on the sequence or sub-sequence to make optimal decisions based on the content. Hence, rate control algorithms try to estimate the motions and cost of transmitting residual information of future frames when adapting the quantization of the current frame, based on current and past already reconstructed frames. However, most existing and deployed Rate Control methods heavily rely on empirically crafted methods to adapt. More recent Machine Learning oriented methods like in [1] use machine learning mechanisms to address QP variations, however, the approach remains limited in its actions on the QP and is not easily adaptable depending on video compression use cases.

### Reinforcement Learning for Rate Distortion Optimization in the Context of Traditional Video Compression

DeepMind at Google published a recent work [2] in which they propose to use an adaptation of their reinforcement learning algorithm MuZero to optimize a bit budget over a group of frames by tuning the quantization parameter of the VP9 standard [3].

The reference software of VP9 includes a two-pass encoding strategy. The first pass extracts relevant information-known as the first pass statistics-about the textures to encode. These statistics help the second and final pass make informed encoding decisions that consider the whole frame, instead of just the current block to encode. Contrary to the final pass, where blocks can have variable sizes from 4×4 to 64×64, images are partitioned into 16×16 non-overlapping blocks to extract this information more quickly.

The first pass statistics of the frame in the current time step, along with additional information such as compression statistics of the frames processed so far, percentage of bit budget already used so far, etc., is used by the MuZero reinforcement learning agent to determine its actions, i.e. determine the QP offset for the current frame in order to achieve an optimal rate distortion tradeoff.

The algorithms that these reinforcement learning agents use to learn to take optimal actions, such MuZero or PPO [4], work based on a feedback loop. The agent decides on an action based on the state of the environment. The chosen action is applied to the environment, which causes it to transition to a new state. The environment then returns the new state and a reward metric to the agent. Hence, during training, an agent receives a reward for each action it takes that indicates how good or bad the action was. The agent then adjusts its internal parameters in order to maximize the cumulative reward it gets.

### End-to-End Deep-Learning Oriented Video Compression

In recent years, novel image and video compression methods based on Artificial Neural Networks have been developed. Contrary to traditional methods which apply pre-defined prediction modes and transforms, ANN-based methods rely on parameters that are learned on a large dataset during training, by iteratively minimizing a loss function. In a compression case, the loss function describes both an estimation of the bitrate of the encoded bitstream, and the performance of the decoded content, like the Lagrangian criterion:

$$J = R + λ D$$

described earlier.

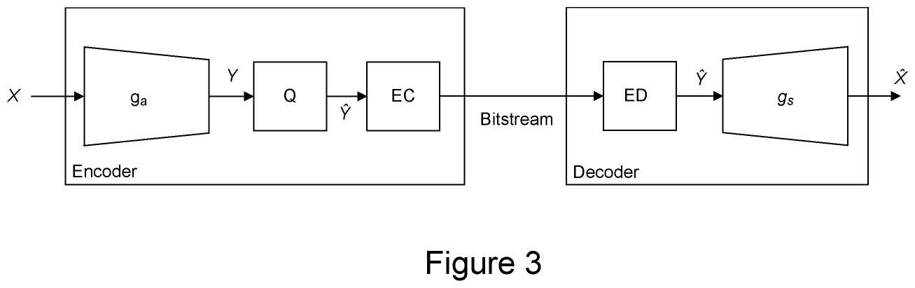

FIG. 3 presents a basic exemplary autoencoder pipeline.

The input X to the encoder part of the network can consist of
1. an image or frame of a video,
2. a part of an image,
3. a tensor representing a group of images, or
4. a tensor representing a part (crop) of a group of images.

In each case, the input can have one or multiple components, e.g.: monochrome, RGB or YCbCr components.
1. The input tensor X is fed into the encoder network. The encoder network is usually a sequence of convolutional layers with activation functions. Large strides in the convolutions or space-to-depth1 operations can be used to reduce the spatial resolution while increasing the number of channels. The encoder network can be considered a learned nonlinear transform.
2. The output of the encoder network is a “feature map” or “latent” Y. This is quantized to Ŷ, resulting in a tensor which is entropy coded (EC) as a binary stream (bitstream) for storage or transmission.
3. The bitstream is entropy decoded (ED) to obtain Ŷ at the decoder-side.
4. The decoder network generates \hat{X}, an approximation of the original X tensor from the latent Ŷ. The decoder network is usually a sequence of up-sampling convolutions (e.g.: “deconvolutions” or convolutions followed by upsampling filters) or depth-to-space operations. The decoder network can be seen as a learned inverse transform, or a denoising and generative transform.

Note that more sophisticated architectures exist, for example adding a “hyper-autoencoder” (hyper-prior) to the network in order to jointly learn the latent distribution properties of the encoder output. The embodiments proposed here are not limited to the use of autoencoders. Any end-to-end differentiable codec can be considered.

Like in the above description, in the following & denotes a quantized version of X.

For a long time, State-Of-The-Art models were trained for each Lagrangian parameter λ, resulting in the necessity of having several pre-trained models to evaluate the performance on a range of bitrates. Each trained set corresponds to millions of parameters, which makes the use of such codec impossible in real life applications. For instance, H.265/HEVC has a granularity of 51 QPs. Adapting for a particular bitrate with such a granularity would result in decoders having 51 pre-trained models in memory and be able to switch on the fly for rate control. ¹Reshaping and permutation, for example a tensor of size (N, H, W) is reshaped and permuted to (N*2*2, H//2, W//2)

To address the memory needs and avoid having to switch models, the authors of [5] proposed AG-VAE (Asymmetric Gained Variational Auto-Encoder) In the following, we consider a latent tensor Y having dimensions C×H×W, where H and W denote the height and width of the tensor and often are a fraction of the input X's resolution, and C denotes the number of channels. Prior to quantization, this latent tensor is multiplied element-wise by a gain vector of shape C×1×1, i.e., the elements of the i-th channel in Y are multiplied by the i-th element of Gₑ. At the decoder, the entropy decoded (ED) tensor is also multiplied by an inverse gain vector G_{d} before being fed to the synthesis function gₛ to reconstruct the output \hat{X} Note that we use this basic version of the gain unit as example in the following, but the proposed embodiments can be extended to more advanced mechanisms, e.g. spatially adaptive gain instead of one value per channel.

Instead of requiring a full set of trained parameters for each operation point, i.e., each lambda, this model just requires a list of vectors Gₑ and its corresponding G_{d}. At training, these vectors can be randomly selected so that gₐ and gₛ are trained for all selected lambdas, whereas each vector is optimized for one lambda only. At the inference, i.e. actual use of the codec, either the proper gain vectors are selected from the list, or they can even be interpolated to refine the targeted bitrate.

In the above descriptions, we factored all the transmitted information as a tensor for simplicity, as if the input always consists of an image X only. However, in the case of video compression, different tensors can be computed and transmitted, depending on the type of frames considered. In the following, we describe an exemplary video model which specifies different models of Intra (I) pictures and Predicted (P) pictures.

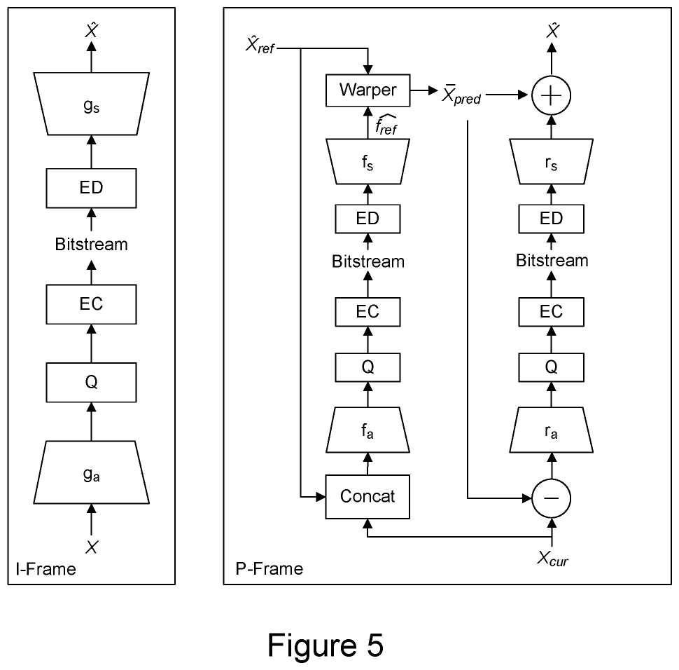

FIG. 5 shows a video compression framework based on state-of-the-art published models. It processes I frames and P frame with two separate architectures. I frames are processed like in image compression, i.e. with the same process as in the previously described model. P frames can be further compressed using the information already reconstructed, i.e. past decoded frames. A warper is used to map the reference picture onto the current picture to encode to form a predictor. This warper uses a motion model [symbol] which is estimated, compressed and transmitted using an auto-encoder similar to those used for image compression, the difference being that the input is a concatenation along the channel axis of the reference and current pictures, e.g., a 6-channel tensor in the case of 3 channel RGB input frames.

Then, like in traditional compression, a residual is formed as the difference between the predictor and the source signal. This residual is compressed and transmitted the same way as I frames, i.e., using a dedicated auto-encoder as shown in FIG. 5.

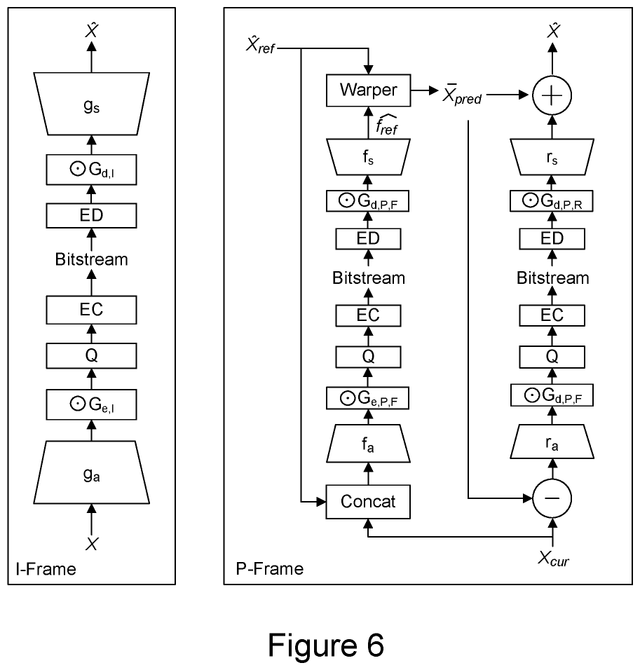

In FIG. 6 is shown an exemplary gained version of the above video compression pipeline. Each autoencoder now includes gain units at encoder and decoder sides. For a specific lambda for an I frame, the model uses a pair (G_{e,I}, G_{d,I}) like for images, where I marks vectors corresponding to I-frames. However, P-frames now use a quadruplet (G_{e,P,F}, G_{d,P,F}, G_{e,P,R}, G_{d,P,R}) where F and R stand for motion Flow and Residual, respectively. Note that the method can be trivially extending to bi-prediction by having associated gains (G_{e,B,F}, G_{d,B,F}, G_{e,B,R}, G_{d,B,R}).

The embodiments described herein aim to optimize the compression of a bitstream by efficiently spending a bit budget for a group of pictures, or subsequence of an input video.

Reference encoders typically organize the process of video sequences in groups of pictures (GOPs) in which the pictures can be coded relying on previously reconstructed ones, following a predefined temporal structure. That structure is typically used to empirically assign a Quantization Parameter (QP) to each frame, depending on its position in the GOP and the interdependencies between frames.

Professional encoders build on top of this to elaborate Rate Control methods which extract features of the video content to come up with a QP strategy that fits the bit budget goal. Those usually use engineered methods which can remain suboptimal. The work by DeepMind described above addresses that issue by using a Reinforcement Learning (RL)-based mechanism in the context of traditional video coding, relying on information computed from a fast past encoder estimation.

The proposed methods in this description also utilize the strength of an RL algorithm when optimizing the compression under a bit budget constraint. However, it can operate on novel end-to-end NN-based video compression systems. It provides means to adapt the bitrate from the encoder and the syntax and mechanisms to convey the information to the decoder.

In the proposed embodiments, it is proposed to perform the optimization of the compression over a sequence of frames under a bit budget constraint using reinforcement learning. We propose to take advantage of the structure of some compression auto-encoder to make the RL algorithm rely on the relevant data.

In particular, some variants of the proposed solution leverage the AG-VAE architecture described in Section 1, in which a gain is applied after an analysis transform gₐ at the encoder. This means that in this encoder architecture, the latent tensor Y=gₐ(X) is always the same for any lambda that the encoder is operating at. This is because the rate-control mechanism involves a multiplication by a lambda-dependent gain vector and quantization, which occurs after Y has already been computed. The latent tensor Y thus provides meaningful information for the RL agent about the compressibility of the input. In contrast, DeepMind's work relies on a first encoding pass that considers limited encoding choices to estimate the bit cost of the frame for the given encoder settings.

### Main Generic Method

The main idea of the described embodiments is to optimize the rate distortion tradeoff for a GoP (subsection of a video) by choosing the amount of bit allocation on a per-frame basis. This may be done under the constraint of a target bitrate or a limit bitrate for that GoP. At each frame, the RL agent decides how much of the bit budget to allocate. This corresponds to choosing a tradeoff point in the rate-distortion curve. Among other possibilities, one such strategy for varying the rate-distortion tradeoff for a neural network-based compression model is to use the AG-VAE architecture explained in Section 1.4. The following is the proposed method which uses AG-VAE as a means of optimizing the rate-distortion tradeoff. Note that this system can work with any other rate-control method.

Frames from the GoP are fed into the system one at a time. For any given frame, the RL agent takes as input the encoded latent of the current frame, among other information such as the bit budget used so far. The agent then outputs its decision on how many bits to allocate for the current frame. Using this decision, the rate-control mechanism encodes the frame at the chosen bitrate. In this case, the rate-control mechanism chooses a gain and inverse gain vector for the frame's target bitrate.

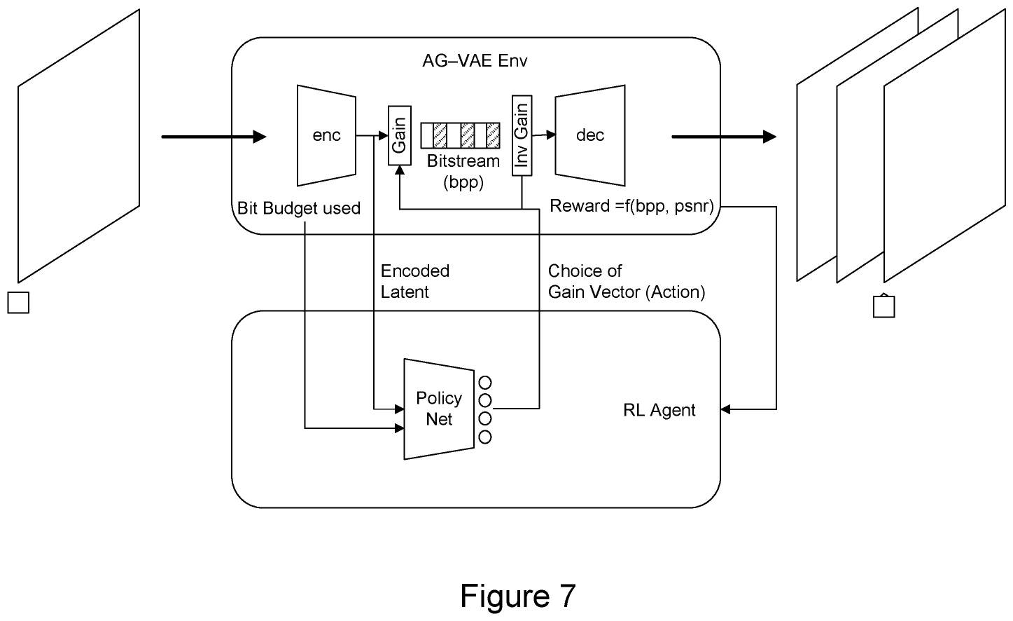

Internally, the agent uses a policy network as depicted at the bottom of FIG. 7—which in this case is a deep convolutional neural network—to decide the frame bit allocation. The agent gets a reward based on how well it optimizes the rate-distortion tradeoff for the GoP. For instance, this reward may be computed based on the total distortion across the sequence of frames with a penalty for exceeding the bit budget. In the example of FIG. 7, the distortion is measured using PSNR, the bitrate is expressed as bpp (bits per pixel). This reward is used to compute the gradients of the policy network needed to improve the agent's decision making. The RL training algorithm iteratively modifies the parameters of the policy network to maximize the reward it receives for each GoP.

### Different State Spaces and Action Spaces

The input to the RL agent is the state of the environment. The set of all possible states that the environment can be in is called the state space. A well-designed state space for an RL system should consist of all the information that the agent needs in order to decide its action.

Similar to state space, the set of all possible actions that the RL agent can take in the environment is called the action space.

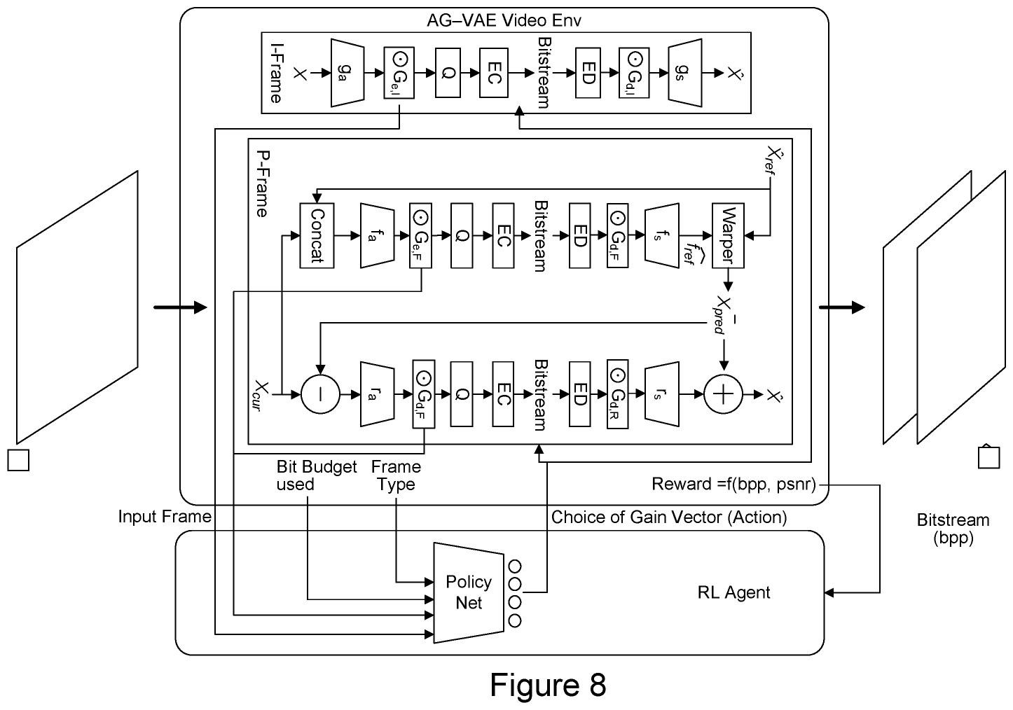

For our proposed method of using RL for rate-distortion optimization at the GoP level, we could have a variety of formulations of the state space and the action space based on the specifics of the video compression model. For example, the system depicted in FIG. 7 has as its state space the encoded latent of the frame plus the bit budget used so far in the GoP. Some systems use the frame directly instead of the encoded latent such as the one in FIG. 8, which also has as another additional state space feature, an indication as to what type of frame is being processed. Another possible state space representation is to have a concatenated tensor of all possible gain vector, encoded latent multiplications.

Similarly, the action space could also be formulated in a few different ways. One possibility is to have a discrete action space where the agent just chooses between predetermined bitrate points. Another possibility is to have a continuous action space where the agent chooses from a range of bitrate points. This action space could be applicable to systems with rate control mechanisms that support continuous rate control, such as AG-VAE.

The system variants described in the following sections use particular state spaces and action spaces described above for the purpose of illustration. However, the system is not restricted to using that particular example and is compatible with various other state and action spaces.

Simple Variant when Video is Processed in Still Picture Mode

In an embodiment, we consider the case where the video is processed in all intra mode. i.e. each picture is encoded independently. The description above can apply directly.

### Adaptation of the Proposed Method on Top of Video Architectures

As mentioned in an earlier section, in most video compression models, different types of frames (such as I-frames and P-frames) are processed differently. Our proposed method is compatible with such video compression models as well, as shown in FIG. 8.

The RL agent could now take as additional input, the type of frame it is processing. And its action space could be discrete, i.e. choice of gain vectors (G_{e,I}, G_{d,I}) if it is an I-frame and choice of gain vectors (G_{e,P,F}, G_{d,P,F}, G_{e,P,R}, G_{d,P,R}) if it is a P-frame, where F stands for motion Flow and R for Residual. Another possibility is to have a continuous action space

### Adaptation of the Proposed Method on Top of Hyperprior Architectures

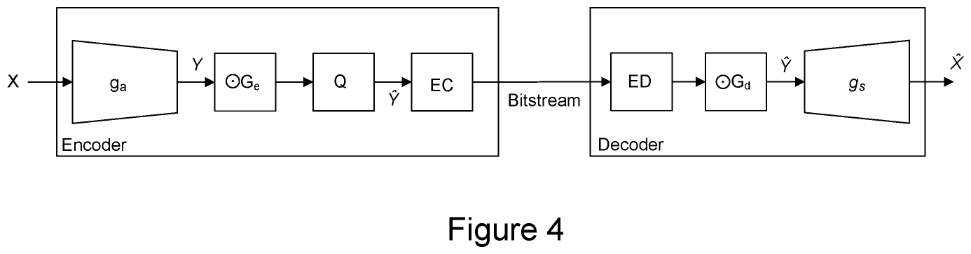

The above description of AG-VAE was using the most basic autoencoder chain, in which we did not detail the entropy bottleneck and entropy coder and decoder (EC/ED in the above figures). Advanced methods use a hyperprior model to estimate the statistical distributions of each element of the latent tensor Ŷ. In that case, a second tensor Z is also quantized, and entropy coded. The exact same Gain Unit mechanism can be applied to the hyperprior tensor Z, with Gₑ^{h}, G_{d}^{h} having dimensions c^{h}□1□1 where c^{h} denotes the number of channels of Z. FIG. 4 depicts such an architecture where Ŷ is analyzed by hₐ which provides per element entropy model parameters to the entropy coder of Ŷ. This side information also needs to be transmitted within the bitstream so that the hyperprior decoder can recreate via hₛ the entropy model to reconstruct Ŷ.

Each operating point lambda is now characterized by a quadruplet {Gₑ Gₑ^{h}, G_{d}, G_{d}^{h}}. Therefore, it does not change the indexing and information to be transmitted to the decoder which contains a list of gains of the same size as the encoder and can interpolate the values of two vectors the same way.

### Proposed Normative Syntax

In the case of traditional video compression, the Quantization Parameter (QP) is generally transmitted per frame, or per slice of a frame. Note that it is possible to transmit QP offset at block level to spatially adapt the target quality. One symbol coding for values in the range 0-51 is transmitted per-frame, QP offset mechanisms can even reduce the cost of that element.

### No Interpolation Between Gain Vectors

In the case of the AG-VAE architecture without gain interpolation, a pair of vector Gₑ and G_{d} can be selected among the list of n vectors the model was trained with. This would require the bitstream to include the index of the chosen pair among the n vectors, i.e., a positive integer number relatively small, e.g., less than 256, hence coded on 8 bits. This syntax element can be encoded per frame or tile of frame if frames are partitioned and processed tile by tile with corresponding autoencoders.

### Interpolation Between 2 Pre-Trained Vectors

In case the number of pre-defined gain vectors corresponding to lambda points is small, it is possible to interpolate between to vectors using the target lambda value. To interpolate between two of the existing pre-trained vectors, available at both encoder and decoder, the decoder needs the information necessary to reconstruct the proper gain vector.

In a first embodiment, we suppose that the decoder has a mechanism to parse a lambda transmitted with the bitstream. Each pre-defined vector is associated with a lambda value it was trained for. The decoder then determines the index of the vector whose corresponding lambda is lower and closest to the target lambda. Then, it can interpolate the values of the vectors between the latter vector and the one corresponding to the consecutive index number, using the target lambda and the lambda values of both surrounding vectors.

The lambda value can then be directly transmitted within the bitstream. As lambda is generally a real number, it would need to be rounded down to the nearest value at a pre-fixed precision. Since codecs usually avoid sharing floating point numbers between the encoder and the decoder, the transmitted lambda should be expressed as fixed-point values.

In a second variant, it is proposed to transmit 2 variables to specify the target vector:
the index of the pre-trained vector whose lambda is closest and less than the target lambda
the interpolation ratio between the two consecutive pre-trained vectors considered for the operation. This interpolation ratio has a value between 0 and 1 and can be easily represented as an unsigned integer depending on the chosen interpolation precision.

This duplet of syntax element can be more efficient in terms of number of bits they require for transmission as well as a slightly less complex interpolation operation at the decoder since the interpolation ratio is directly transmitted and does not need to be computed.

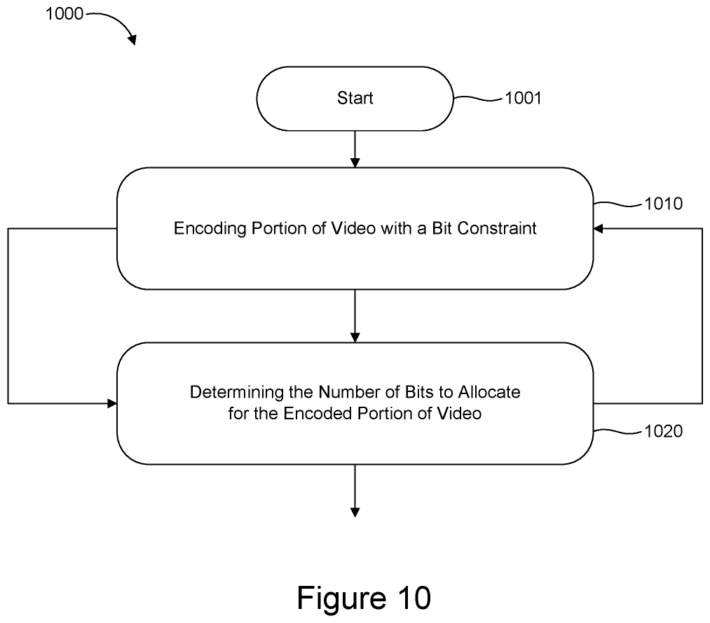

One embodiment of a method 1000 for encoding video data is shown in FIG. 10. The method commences at Start bock 1001 and proceeds to block 1010 for encoding a portion of video using a determined number of bits. Control proceeds from block 1010 to block 1020 for determining the number of bits to allocate for the encoded portion of video based on a number of frames, wherein said determining comprises using a gain vector from a reinforcement learning agent that uses a latent determined from the encoding.

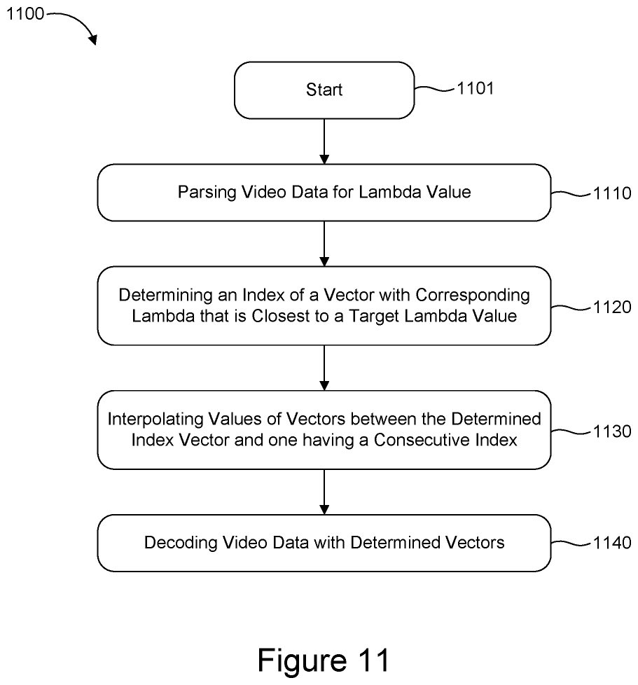

One embodiment of a method 1100 for decoding video data is shown in FIG. 11. The method commences at Start block 1101 and proceeds to block 1110 for parsing video data for a lambda value. Control proceeds from block 1110 to block 1120 for determining an index of a vector with corresponding lambda that is closest to a target lambda value, wherein lambda defines a rate-distortion operating point. Control proceeds from block 1120 to block 1130 for interpolating values of vectors between the determined index vector and one having a consecutive index, using the target lambda value and lambda values of the vectors between the determined index vector and one having a consecutive index. Control proceeds from block 1130 to block 1140 for decoding the video data using the interpolated vectors

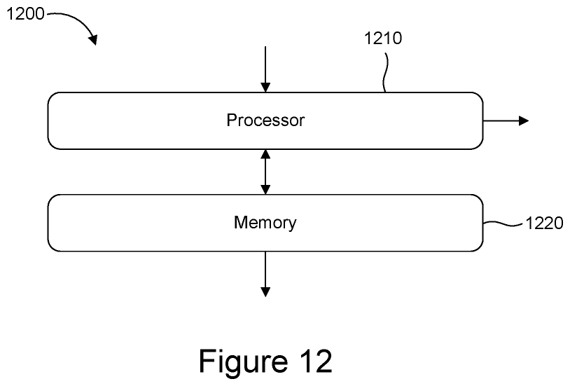

FIG. 12 shows one embodiment of an apparatus 1200 for compressing, encoding or decoding video using the aforementioned methods. The apparatus comprises Processor 1210 and can be interconnected to a memory 1220 through at least one port. Both Processor 1210 and memory 1220 can also have one or more additional interconnections to external connections.

Processor 1210 is also configured to either insert or receive information in a bitstream and, either compressing, encoding, or decoding using the aforementioned methods.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

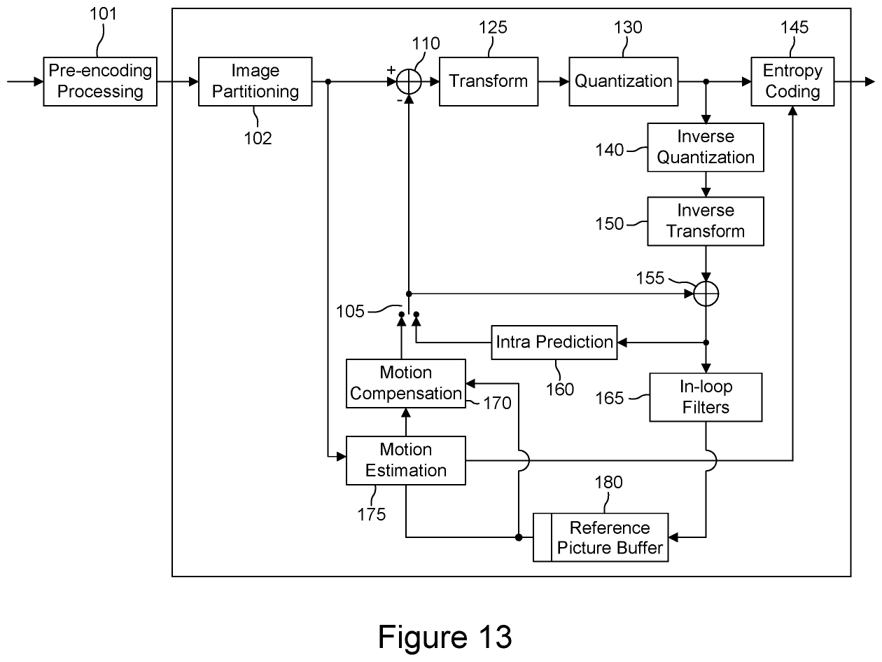

The aspects described and contemplated in this application can be implemented in many different forms. FIGS. 13, 14, and 15 provide some embodiments, but other embodiments are contemplated and the discussion of FIGS. 13, 14, and 15 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” or “reconstructed” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

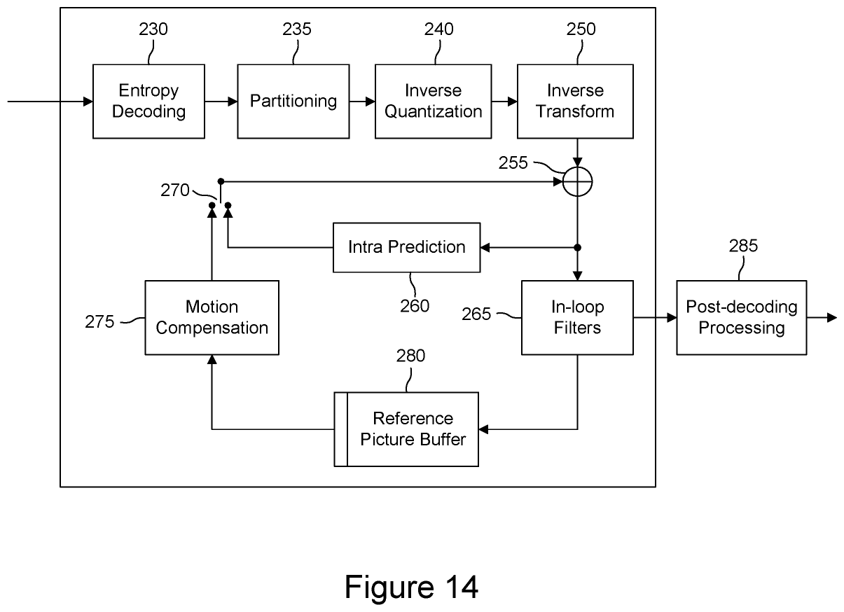

Various methods and other aspects described in this application can be used to modify modules, for example, the intra prediction, entropy coding, and/or decoding modules (160, 360, 145, 330), of a video encoder 100 and decoder 200 as shown in FIG. 13 and FIG. 14. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 13 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 14 illustrates a block diagram of a video decoder 200. In the decoder 200, a bitstream is decoded by the decoder elements as described below. Video decoder 200 generally performs a decoding pass reciprocal to the encoding pass as described in FIG. 13. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

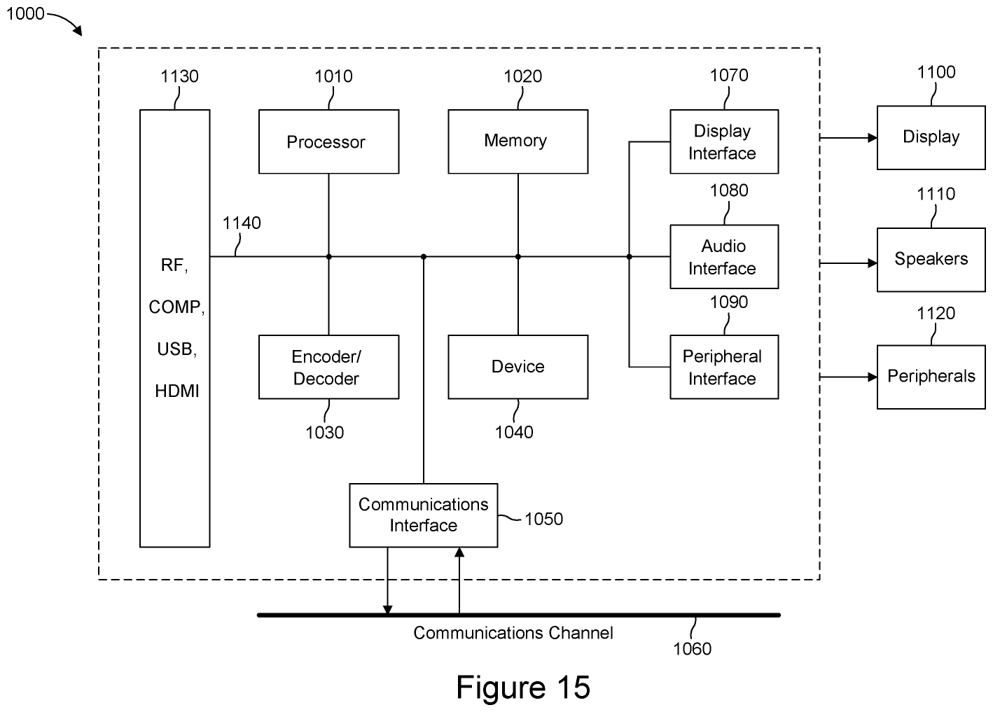

FIG. 15 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices). and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 15, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types. At least one embodiment comprises the following features:

Encoding and decoding of video information using neural networks.

Determining the number of bits to allocate for the encoded portion of video based on a number of frames, using a gain vector from a reinforcement learning agent that uses a latent determined from the encoding.

Encoding and decoding using an Asymmetric Gained Variational Auto-Encoder A reinforcement agent implemented with a deep neural network

The above encoding and decoding further comprising data indicative of latents is included in a coded bitstream.

A bitstream or signal that includes one or more of the described syntax elements, or variations thereof.

A bitstream or signal that includes syntax conveying information generated according to any of the embodiments described.

Creating and/or transmitting and/or receiving and/or decoding according to any of the embodiments described.

Parsing video data or a bitstream to determine operating point of a codec.

A method, process, apparatus, medium storing instructions, medium storing data, or signal according to any of the embodiments described.

Inserting in the signaling syntax elements that enable the decoder to determine decoding information in a manner corresponding to that used by an encoder.

Creating and/or transmitting and/or receiving and/or decoding a bitstream or signal that includes one or more of the described syntax elements, or variations thereof.

A TV, set-top box, cell phone, tablet, or other electronic device that performs transform method(s) according to any of the embodiments described.

A TV, set-top box, cell phone, tablet, or other electronic device that performs transform method(s) determination according to any of the embodiments described, and that displays (e.g., using a monitor, screen, or other type of display) a resulting image.

A TV, set-top box, cell phone, tablet, or other electronic device that selects, bandlimits, or tunes (e.g., using a tuner) a channel to receive a signal including an encoded image, and performs transform method(s) according to any of the embodiments described.

A TV, set-top box, cell phone, tablet, or other electronic device that receives (e.g., using an antenna) a signal over the air that includes an encoded image, and performs transform method(s).

1. A method, comprising:
encoding a portion of video using a determined number of bits; and,
determining the number of bits to allocate for the encoded portion of video based on a number of frames, wherein said determining comprises using a gain vector from a reinforcement learning agent that uses a latent determined from the encoding.

2. An apparatus configured to perform:
encoding a portion of video using a determined number of bits; and,
determining the number of bits to allocate for the encoded portion of video based on a number of frames, wherein said determining comprises using a gain vector from a reinforcement learning agent that uses a latent determined from the encoding.

3. A method, comprising:
parsing video data for a lambda value;
determining an index of a vector with corresponding lambda that is closest to a target lambda value, wherein lambda defines a rate-distortion operating point;
interpolating values of vectors between the determined index vector and one having a consecutive index, using the target lambda value and lambda values of the vectors between the determined index vector and one having a consecutive index; and,
decoding the video data using the interpolated vectors.

4. An apparatus configured to perform:
parsing video data for a lambda value;
determining an index of a vector with corresponding lambda that is closest to a target lambda value, wherein lambda defines a rate-distortion operating point;
interpolating values of vectors between the determined index vector and one having a consecutive index, using the target lambda value and lambda values of the vectors between the determined index vector and one having a consecutive index; and,
decoding the video data using the interpolated vectors.

5. The method of claim 1, wherein an Asymmetric Gained Variational Auto-Encoder (AG-VAE) architecture is used.

6. The method of claim 1, wherein the reinforcement learning is implemented by a Deep Neural Network (DNN).

7. The method of claim 1, wherein said number of frames is a Group of Pictures (GOP).

8. The method of claim 1, wherein said reinforcement learning agent determines a range of bitrate points.

9. The apparatus of claim 2, wherein the video processed is all intra mode prediction.

10. The method of claim 1, wherein the reinforcement learning agent receives frame type as input.

11. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of a video block.

12. A non-transitory computer readable medium containing data content generated according to the method of claim 1, for playback using a processor.

13. (canceled)

14. A computer program product comprising instructions which, when the program is executed by a computer, cause the computer to carry out the method of claim 3.

15. A non-transitory computer readable medium containing data content comprising instructions to perform the method of claim 1.

16. The method of claim 3, wherein an Asymmetric Gained Variational Auto-Encoder (AG-VAE) architecture is used.

17. The apparatus of claim 2, wherein the reinforcement learning is implemented by a Deep Neural Network (DNN).

18. The apparatus of claim 2, wherein said number of frames is a Group of Pictures (GOP).

19. The apparatus of claim 2, wherein said reinforcement learning agent determines a range of bitrate points.

20. The method of claim 3, wherein the video processed is all intra mode prediction.

21. The apparatus of claim 2, wherein the reinforcement learning agent receives frame type as input.
